(19) United States
(12) Patent Application Publication
(10) Pub. No.: US 2020/0145031 A1
(43) Pub. Date: May 7, 2020

(54) COMMUNICATION SYSTEM FOR AIRCRAFTS WITH ALTITUDE BASED FREQUENCY BAND SELECTION

(71) Applicant: Icomera AB, Göteborg (SE)

(72) Inventors: Mats KARLSSON, Vålberg (SE); Peter EKLUND, Göteborg (SE)

(73) Assignee: Icomera AB, Göteborg (SE)

(21) Appl. No.: 16/613,148

(22) PCT Filed: May 17, 2018
(86) PCT No.: PCT/EP2018/062868

§ 371 Date: Nov. 13, 2019

(30) Foreign Application Priority Data
May 17, 2017 (SE) 1750612-2

(51) Int. Cl. H04B 1/00; H04W 72/04; G01C 5/00; G01S 19/13

(52) U.S. Cl. CPC H04B 1/0064; G01S 19/13; G01C 5/005; H04W 72/0453

(57) ABSTRACT

A system and method for providing wireless data communication between a wireless communication system in an aircraft and a stationary communication server outside the aircraft are disclosed. The wireless communication system comprises at least one antenna, an altitude determining unit, and a router in the aircraft configured to transmit and receive wireless data communication to and from a stationary communication server outside the aircraft through at least one ground base station via the at least one antenna on a plurality of different frequency bands. The router comprises a control unit configured to disable wireless data communication on at least one frequency band when the current altitude of the aircraft is determined to be above an altitude threshold value. Hereby, it is possible to provide a more stable data link between clients connected to the aircraft wireless communication system and remote external servers.

### TECHNICAL FIELD OF THE INVENTION

The present invention relates to the field of wireless communication technology, and more specifically to a wireless communication system and method particularly suitable for aircrafts, such as helicopters and airplanes.

### BACKGROUND

It is not an understatement that the last few decades have introduced vast improvements and advancements in the field of communication technology. In fact, the advent of the internet, cellular phones and more recently smart phones and tablets has greatly changed the way we communicate and quite possibly accelerated the technological field surrounding these devices. As an inevitable consequence, there is an ever increasing demand for bandwidth in order to satisfy the market need for online connectivity which results in an increased focus on constantly developing and improving the underlying technology and systems in order to accommodate this demand.

Further, there is a rapidly increasing demand from consumers to be able to communicate through mobile phones and other handheld terminals at all times, even while traveling on trains, busses, ships and even aircrafts. This is partially embodied in the increasing availability of in-flight entertainment systems and wireless communication (Wi-Fi, GSM, 3G, LTE, 5G) capability onboard aircrafts.

Wireless communication capability onboard aircrafts is not a new concept, even the earliest commercial aircrafts had rather primitive voice communication capability with ground personnel over shortwave radio, which improved flight safety and enabled accelerated commercialization of air transport. Since then, airborne communication systems have been further improved with advent of radar, computers and data links, which serve to improve in-flight safety as well as the overall traveling experience for passengers.

However, regardless of recent developments of communication platforms for aircrafts, it has proven to be difficult for presently known systems to provide robust, broadband communication for aircrafts such as helicopters, airplanes and the like.

Thus, in view of the above, there is a need for an improved wireless aircraft communication system which provides better capacity, improved reliability while still being cost effective.

### SUMMARY OF THE INVENTION

It is therefore an object of the present invention to provide a wireless communication system and method for an aircraft, such as a helicopter or an airplane, which alleviates all or at least some of the drawbacks of presently known systems. Another object of the invention is to provide a means for robust and stable wireless connectivity in aircrafts.

This object is achieved by means of a wireless communication system and method for wireless data communication between a wireless communication system in an aircraft and a stationary communication server outside the aircraft, as defined in the appended claims.

According to a first aspect of the present invention, there is provided a wireless communication system for an aircraft. The wireless communication system comprises:

at least one antenna;

a router connected to the at least one antenna, wherein the router is configured to transmit and receive wireless data communication to and from a stationary communication server outside the aircraft through at least one ground base station via the at least one antenna, wherein the router is configured to transmit and receive wireless data communication on a plurality of different frequency bands;

an altitude determining unit configured to determine a current altitude of the aircraft; and

wherein the router comprises a control unit operably connected to the altitude determining unit, the control unit being configured to disable wireless data communication (to and from the stationary communication server) on at least one frequency band when the current altitude is determined to be above an altitude threshold value.

The inventive aircraft communication system is capable of selecting frequency bands for wireless data communication (between the router and the ground base station(s)) based on a current altitude of the aircraft in order to optimize performance at high and low altitudes.

The present invention is based on the realization that the cellular data link quality decreases at higher altitudes for wireless data communication systems arranged within aircrafts. It was further realized that the data links established at the “higher” frequency bands (e.g. 1800 MHz or 2600 MHz) exhibited connectivity issues. This negatively affected the overall performance of the communication system since telecom systems generally prioritize higher frequency bands, e.g. due to higher capacity in these bands. However, the higher frequency bands are sensitive to the negative/destructive interference caused by the large number of available cells/ground base stations, and also to aircraft movement (pitch, roll, yaw). Thus, the present inventors realized that by disabling communication possibilities at certain frequency bands at high altitudes (e.g. above 500 m), and in particular higher frequency bands, and consequently forcing the system to communicate at the remaining, preferably lower, frequency bands (e.g. 600, 700, 800 MHz) at these high altitudes the overall system performance can be increased, in particular since the lower frequency bands generally have larger cells and are more robust. Due to antenna and base station design, lower frequency bands also normally emit more radio signals upwards than higher frequency bands, and are therefore easier to access from high altitudes.

The altitude threshold value may be one or several predefined, static value(s). The same altitude threshold value(s) may be used for each frequency band to be disabled at high altitudes. However, different altitude threshold values may also be used for one and the same frequency band, depending on e.g. the antenna type. Thus, the altitude threshold values may be specific for each antenna or antenna group, and be set in dependence on e.g. antenna gain, antenna directivity and the like. Instead of using static, predefined altitude threshold value(s), the altitude threshold value(s) may be set and adjusted dynamically, in dependence on the context and present conditions. For example, the link and/or signal quality may be monitored when the aircraft is moving upwards, and when the link or signal quality becomes too poor, an altitude threshold value may be set at the altitude when this was detected, thereby disabling one or several frequency bands when the aircraft remains at altitudes above this threshold value.

The “router” is preferably a networking router, which is a machine that forwards data packets between computer networks, preferably on at least two data links in each direction. Stated differently, the networking router is capable of providing data communication between an internal local area network (arranged within the aircraft) and an external wide area network (WAN) outside the aircraft. The router may be a mobile access router (MAR), and preferably a mobile access and applications router (MAAR). The router further comprises means (e.g. a control unit or controller) for controlling which frequency bands are to be used at which altitudes. More specifically, the router preferably comprises means for selecting/defining a set of “higher” frequency bands which are to be disabled once the aircraft exceeds a certain altitude threshold value in order to force or restrict the wireless data communication between the aircraft and the ground base station(s) to one or more of the “lower” frequency bands.

In terms of general operation of the communication system, the router and the stationary (remote) communication server are preferably connected through a plurality of exterior mobile/cellular networks (provided by the ground base stations), which are simultaneously useable. Also, the router is preferably arranged to communicate with the stationary communication server on at least two different data links (communication routes) having different characteristics (e.g. on different frequency bands), and then to automatically separate the data traffic between the data links based on an evaluation of link quality. The evaluation of link quality may for example be executed as disclosed in WO 2015/169917, by the same applicant, said document incorporated herein by reference. The data streams are then forwarded on one or several links to and from a dedicated external server, which may be referred to as an aggregation server or gateway. The different links thereby form a single virtual link between the router and the gateway.

The communication can be automatically optimized based on the evaluation, and also optionally on other conditions, such as price, speed, latency, etc. Thus, in addition to the evaluation, prioritizing and assignments may be made based on other static or dynamic parameters, such as signal strength and the like. Such further optimizations are per se known from EP 1 175 757 by the same applicant, said document hereby incorporated herein by reference. An automatic selection is then made among the available data links to use the most efficient combination. Hence, a seamless distribution of the data among the different data links is obtained.

Further, in accordance with an embodiment of the present invention, the plurality of different frequency bands comprises a first frequency band and a second frequency band, the second frequency band being a highest frequency band out of the plurality of frequency bands; and

wherein the control unit is configured to disable wireless data communication on the second frequency band when the current altitude is determined to be above the altitude threshold value. For example, the router may be configured to transmit and receive wireless data communication on a first cellular frequency band (e.g. 700 MHz, LTE) and on a second cellular frequency band (e.g. 1900 MHz, LTE). Naturally, the router may be configured to additionally operate on any number of frequency bands therebetween (e.g. 800 MHz, 900 MHz, 1500 MHz, etc.). Accordingly, once the aircraft passes a certain threshold altitude (e.g. 500 m), the control unit disables wireless data communication on the 1900 MHz band, consequently restricting communication to the one or more available lower frequency bands.

Even further, in accordance with another embodiment the plurality of different frequency bands comprises:

a first set of frequency bands and a second set of frequency bands, wherein each frequency band in the second set of frequency bands is at a higher frequency than each frequency band in the first set of frequency bands; and

wherein the control unit is configured to disable the wireless data communication on the second set of frequency bands, and thereby restrict the wireless data communication only to the first set of frequency bands, when the current altitude is determined to be above an altitude threshold value. A set of frequency bands may comprise one or more frequency bands, but preferably at least two or more, such as three of four different frequency bands. In an illustrative example of the embodiment, the first set of frequency bands may for example include 600 MHz, 700 MHz, 800 MHz and 900 MHz, while the second set of frequency bands may include 1800 MHz and 2600 MHz. Accordingly, when the aircraft is flying at an altitude between ground level and the altitude threshold value (which may be any value between e.g. 200 and 5000 m above the ground level, and preferably between 500 and 3000 m, and most preferably between 500 and 1500 m), the control unit is preferably configured to make all frequency bands available. However, the router may be configured such that it prioritizes selection of the second set of frequency bands when the current altitude of the aircraft is determined to be below the altitude threshold value. This is because connectivity and data rates are generally better on the higher frequency bands on low altitudes. Moving on, once the aircraft passes the altitude threshold value (e.g. 750 m) the control unit disables wireless data communication on the second set of frequency bands, thereby limiting communication only on the first set of frequency bands. The first and second set of frequency bands may be formed such that the first set of frequency bands only comprises frequency bands below 1 GHz (1000 MHz) and the second set of frequency bands only comprises frequency bands above 1 GHz (1000 MHz). A set is in the present context to be understood as a group comprising one or more members/elements. Moreover, the plurality of frequency bands may comprise more than two sets of frequency bands, each set having a different altitude threshold value, above which, the specific set of frequency bands is disabled. Preferably, this disabling disables frequency bands at the highest frequencies first, and then stepwise disables the highest of the remaining frequency bands.

Furthermore, in accordance with another embodiment of the present invention the wireless communication system further comprises a plurality of antennas, and wherein the router further comprises a plurality of modems for communication with said external stationary communication server, each modem being associated with and connected to at least one antenna;

wherein each modem is further associated with a specific frequency band selected from the plurality of frequency bands; and

wherein said control unit configured to disable wireless communication on at least one frequency band when the current altitude is determined to be above a threshold value, by disabling at least one modem. Thus, one may arrange a first set of modems to be associated with the lowest frequency band(s) and a second set of modems to be associated with the highest frequency band(s), and disable the entire second set of modems when the control unit is notified by the altitude determining unit that the aircraft has reached or surpassed the altitude threshold value. For example, the router may be provided with at least 8 modems, preferably at least 10 modems, such as e.g. 15 modems.

Even further, in accordance with yet another embodiment of the present invention, the router comprises a subscriber identity module (SIM) pool including a plurality of SIMs, and wherein said control unit is capable of periodically assigning SIMs within said SIM pool to any one of said modems. Subscriber Identity Modules (SIMs) are per se known, and used to identify and authenticate a user to a wireless network so that the network can authorize the user to set-up data transmissions and calls. A SIM includes a processor and memory, and some types of SIMs are in the form of SIM cards, which can be removed from the SIM holder. A Universal Subscriber Identity Module (USIM) is a next-generation SIM. Hereinafter, both SIMs and USIMs will be collectively referred to as SIMs.

Moreover, by using a common pool of SIMs, accessible for a plurality of modems, the total number of SIMs may be reduced, and the SIMs available may be used more efficiently. At the same time, the accessibility for each modem to an adequate SIM at each time increases, since the number of accessible SIMs for each modem increases. Accordingly, the use of the available SIMs can hereby be managed more efficiently. In particular, it hereby becomes possible to provide access for each modem to one or several suitable SIM(s) in two or more different countries, and in particular in every country in which the aircraft may travel.

Further, in accordance with yet another embodiment of the present invention, the altitude determining unit is configured to continuously monitor and determine the altitude of the aircraft. The altitude determining unit may be integrated within the control unit or a stand-alone component external to the router and associated with an altimeter/altitude meter which is configured to determine an altitude of the aircraft based on e.g. a measurement of atmospheric pressure. The control unit of the router may accordingly be coupled to the external altimeter (i.e. the altimeter of the aircraft).

However, the altitude determining unit may in some embodiments of the present invention be provided within the router, and may furthermore for example be a Global Navigation Satellite System GNSS unit, such as e.g. a GPS-unit, GLONASS-unit, Galileo-unit, etc. depending on the preferred regional system. By providing the altitude determining unit within the router, the wireless communication system becomes a stand-alone system which is easy to install and therefore can be retrofitted into existing aircrafts without requiring any coupling to the aircraft's integrated altimeter. The antennas are preferably arranged external to the router.

Even further, in yet another example embodiment of the present invention, the aforementioned altitude threshold value is a first altitude threshold value, and wherein the control unit is further configured to disable wireless data communication on at least one other frequency band when the current altitude is determined to be above a second altitude threshold value, higher than said first altitude threshold value, such that wireless data communication on at least two frequency bands is disabled when the current altitude is determined to be above the second threshold value. Thus, the control unit is preferably configured to receive and store two or more altitude threshold values, such as three or four altitude threshold values. For example, the control unit may be configured to disable wireless data communication on frequency bands higher than 2.0 GHz when above 500 m (first altitude threshold value), on frequency bands higher than 1.5 GHz when above 1000 m (second altitude threshold value), and on frequency bands higher than 1.0 GHz when above 1500 m (third altitude threshold value). By applying a plurality of threshold values and thereby disabling frequency bands in a sequential manner based on the determined current attitude the wireless data communication system is provided with an optimization scheme which aids in ensuring a robust and speedy connection for the duration of the flight, since one can apply thresholds such that high frequency bands (with high data rates) can be utilized until the communication link quality (on those frequency bands) passes a minimum quality threshold.

As already discussed, one, several or all of the altitude threshold value(s) may also be dynamically adjustable, and may e.g. be adjusted or set in dependence of signal and/or link quality on one or several of the frequency bands.

According to another aspect of the invention, there is provided a method for wireless data communication between a wireless communication system in an aircraft and a stationary communication server outside the aircraft, the method comprising:

providing a router within the aircraft, the router being connected to at least one antenna and configured to transmit and receive wireless data communication to and from the stationary communication server outside the aircraft through at least one ground base station via the at least one antenna, wherein the router is configured to transmit and receive wireless data communication on a plurality of different frequency bands;

determining a current altitude of the aircraft; and

disabling wireless data communication on at least one frequency band out of the plurality of different frequency bands when the current altitude is determined to be above an altitude threshold value.

With this aspect of the invention, similar advantages and preferred features are present as in the previously discussed first aspect of the invention. For example, the method may further comprise: forming a first subset of frequency bands out of the plurality of different frequency bands;

forming a second subset of frequency bands out of the plurality of different frequency bands, each frequency band in the second subset of frequency bands being of a higher frequency than each frequency band in the first subset of frequency bands; and

wherein the step of disabling wireless data communication comprises disabling wireless data communication on the second subset of frequency bands when the current altitude is determined to be above the altitude threshold value.

These and other features and advantages of the present invention will in the following be further clarified with reference to the embodiments described hereinafter.

### BRIEF DESCRIPTION OF THE DRAWINGS

For exemplifying purposes, the invention will be described in closer detail in the following with reference to embodiments thereof illustrated in the attached drawings, wherein:

FIG. 1A is a schematic illustration of an aircraft having a wireless communication system in accordance with an embodiment of the present invention;

FIG. 1B is a schematic illustration of the aircraft from FIG. 1A after is has ascended past an altitude threshold;

FIG. 2A is a schematic illustration of an aircraft having a wireless communication system in accordance with another embodiment of the present invention;

FIG. 2B is a schematic illustration of the aircraft from FIG. 2A after is has ascended past an altitude threshold;

FIG. 3 is a schematic illustration of an aircraft having a wireless communication system in accordance with yet another embodiment of the present invention;

FIG. 4 is a schematic flow chart representation of a method for wireless data communication in accordance with an embodiment of the present invention;

FIG. 5 is a schematic flow chart representation of a method for wireless data communication in accordance with another embodiment of the present invention;

### DETAILED DESCRIPTION

In the following detailed description, preferred embodiments of the present invention will be described. However, it is to be understood that features of the different embodiments are exchangeable between the embodiments and may be combined in different ways, unless anything else is specifically indicated. Even though in the following description, numerous specific details are set forth to provide a more thorough understanding of the present invention, it will be apparent to one skilled in the art that the present invention may be practiced without these specific details. In other instances, well known constructions or functions are not described in detail, so as not to obscure the present invention. In the detailed embodiments described in the following are related to helicopters. However, it is to be acknowledged by the skilled reader that the method and system are correspondingly useable on other aircrafts, such as airplanes and the like.

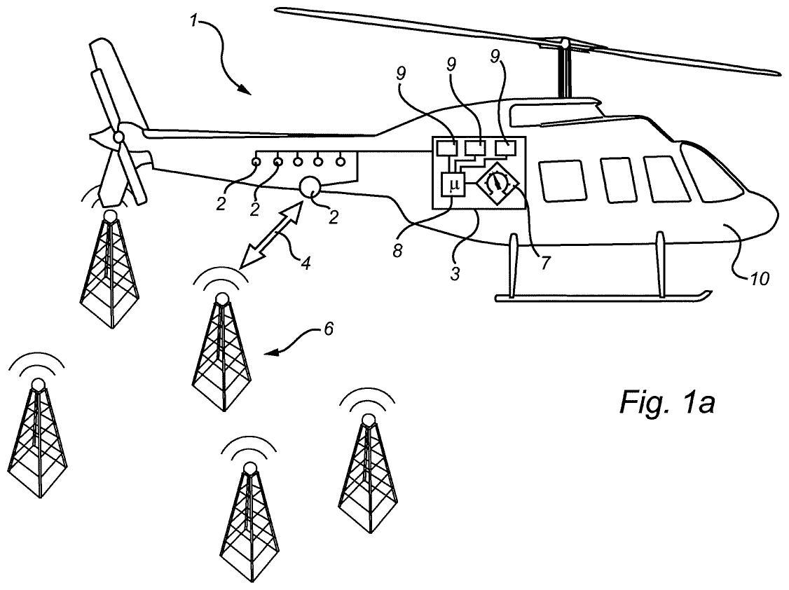

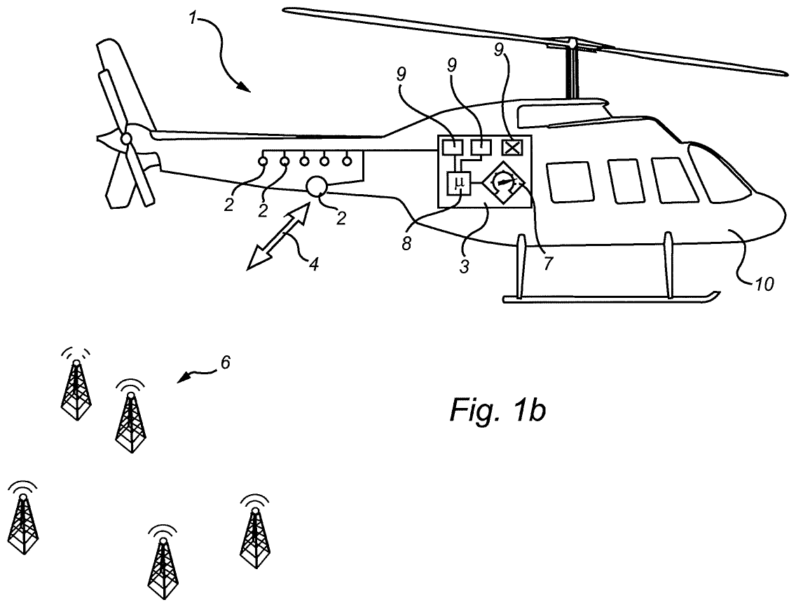

In FIGS. 1a and 1b, schematic illustrations of an aircraft 10, here in the form of a helicopter, having a wireless communication system 1 are presented. The two FIGS. 1a and 1b) are intended to show the same aircraft at two different altitudes, below an altitude threshold in FIG. 1a and above the altitude threshold in FIG. 1b. The wireless communication system 1 comprises a plurality of antennas 2 connected to a data communication router 3 configured to transmit and receive wireless data communication to and from at least one ground base station 6 via the plurality of antennas (as indicated by the double headed arrow 4). Moreover, the router 3 is configured to transmit and receive wireless data communication on a plurality of different frequency bands. The router 3 comprises a plurality of modems 9, each having at least one antenna 2 assigned to each modem 9. However, if e.g. MIMO (multiple input multiple output) is used, more than one antenna 2 may also be assigned to each modem. Even though only 3 modems are illustrated in FIGS. 1a-1b, the skilled reader readily realizes that the router may comprise a higher number of modems 9, such as e.g. at least 8 modems or at least 15 modems. The antennas 2 may be omnidirectional antennas and/or directional/beam antennas depending on the intended application and desired specifications, preferably the system 1 comprises a combination of omnidirectional and directional antennas.

The system 1 further comprises an altitude determining unit 7 configured to determine a current altitude of the aircraft 10. The altitude determining unit 7 is preferably configured to continuously monitor and determine the altitude of the aircraft, and may for example be a Global Navigation Satellite System, GNSS, provided within the router 3, such as e.g. GPS, GLONASS, Galileo system, BeiDou system, etc. By providing a GNSS internally within the router 3, installation of the wireless communication system 1 is facilitated as there is no need for establishing an operational connection between the aircraft's 10 internal altimeter (not shown) and the router. Moreover, the inventive system 1 may thereby easily be retrofitted into existing aircrafts 10.

Further, the router comprises a control unit 8, e.g. a microprocessor, which is connected to the altitude determining unit 7 and to each of the modems 9. The control unit is preferably realized as a software controlled processor. However, the control unit 8 may alternatively be realized wholly or partly in hardware. The control unit 8 is configured to disable wireless data communication on at least one frequency band when the current altitude of the aircraft 10 is determined to be above an altitude threshold value. The disabling of wireless data communication on a frequency band may for example be executed by disabling/turning off a modem 9, as indicated in the illustration of FIG. 1b, which serves to show how the control unit 8 disables a frequency band when the aircraft 10 rises from a first, lower, altitude (FIG. 1a) to a second, higher, altitude (FIG. 1b). This is additionally indicated by the meter representing the altitude determining unit 7 and by the reduced size of the ground base stations 6. The second altitude is to be understood as an altitude higher than the altitude threshold value.

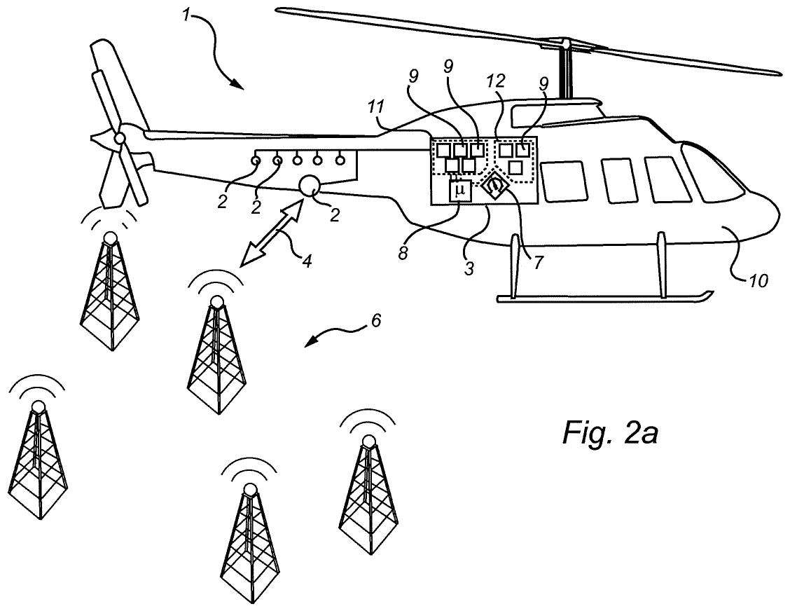

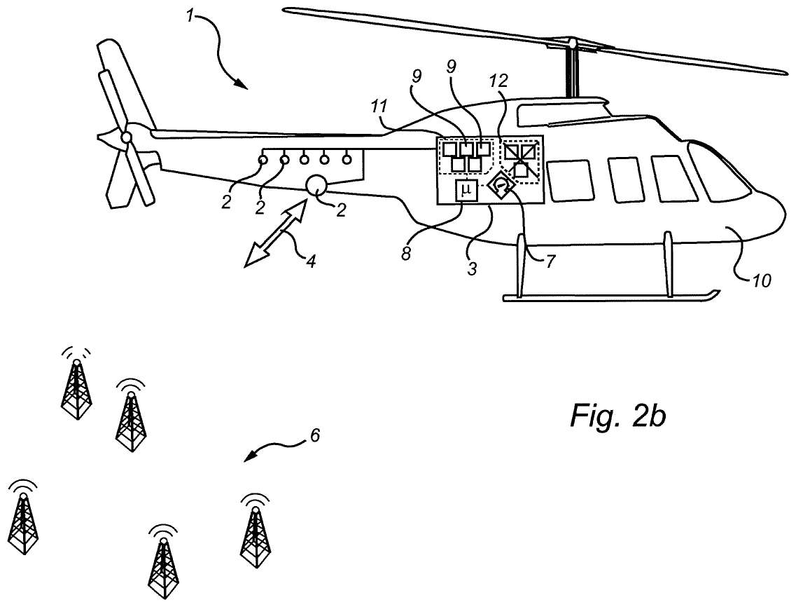

FIGS. 2a-2b schematically illustrate another embodiment of the inventive wireless communication system 1, in a similar fashion as in FIGS. 1a-1b, i.e. FIG. 2a shows an aircraft 10 at first altitude below an altitude threshold value, and FIG. 2b shows the aircraft 10 at a second altitude, above the altitude threshold value. However, in this embodiment, the plurality of functional frequency bands (each being associated with at least one modem 9) comprises a first set of frequency bands 11 and a second set of frequency bands 12. The first set of frequency bands 11 may for example include 600, 700, 800 and 900 MHz, and the second set of frequency bands may for example include 1800, 1900 and 2600 MHz. Further, the router may include more modems 9 than useable frequency bands, e.g. the router may comprise separate modems for different operators, but operating at the same frequency bands.

Accordingly, when the aircraft 10 rises, the control unit 8 is configured to disable wireless data communication on the second set of frequency bands 12, and thereby restrict the wireless data communication only to the first set of frequency bands 11, when the current altitude is determined to be above a threshold value (FIG. 2b illustration). Remaining components and functions illustrated in FIGS. 2a-2b and which have the same reference numerals as in FIGS. 1a-1b are considered to already be discussed in detail, wherefore any detailed description of these will for the sake of brevity be omitted.

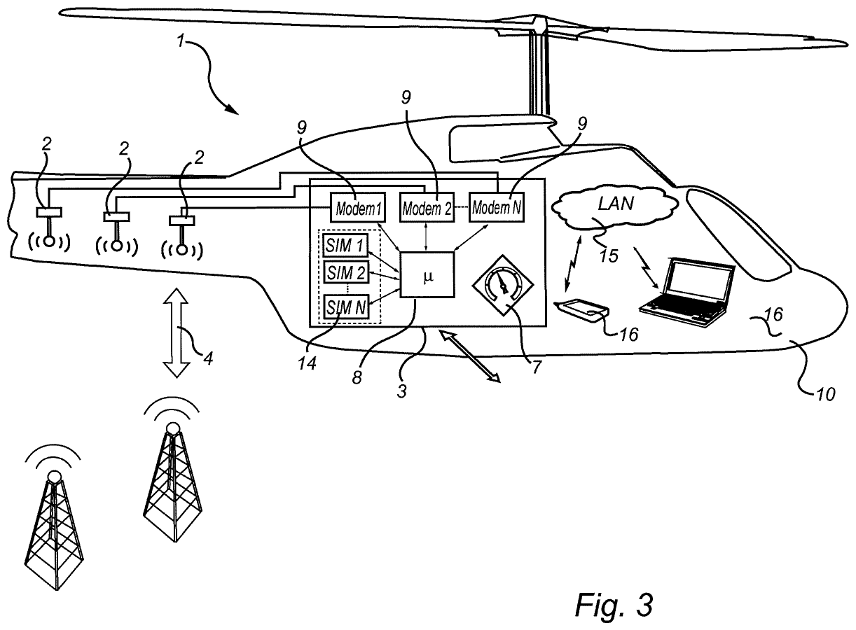

FIG. 3 schematically illustrates yet another embodiment of the inventive wireless communication system 1. Here, the router 3 comprises a subscriber identity module pool (SIM pool) 13 which includes a plurality of SIMs 14, and the control unit 8 is accordingly configured to periodically assign SIMs 14 within the SIM pool 13 to any one of the plurality of modems 9 provided within the router 3. In other words, the SIMs 14 form a common SIM pool 13, accessible for all the modems 9. The SIMs 14 are preferably SIM cards, and the SIM pool 13 is realized as a SIM card holder, comprising a plurality of slots for receiving a plurality of SIM cards 14.

The assignment of SIMs to modems at every specific time is preferably determined based on a set of rules in the controller. The set of rules may e.g. be used to assign SIMs to the modems based on information such as in, the current altitude of the aircraft 10, which country the aircraft is currently travelling, the amount of data that has been conveyed by use of the different SIMs, the current price related to conveying data through the different SIMs, the type of data being conveyed, etc.

Furthermore, FIG. 3 illustrates how the router 3 is configured for receiving and transmitting data between an internal local area network (LAN) 15 and a plurality of external wide ware networks (WANs) 6. The LAN 15 is preferably a wireless network, using one or several internal antennas to communicate with clients 16 within the aircraft 10. To this end, it is e.g. feasible to use a distributed antenna, such as a leaky feeder extending through the vehicle, but other types of antennas may also be used. The wireless network may be realized as a wireless local area network (WLAN), and may e.g. operate based on the IEEE 802.11 standard, (“Wi-Fi”), and wherein one or more access point(s) is provided in the aircraft. However, it is also possible to use a wired network within the vehicle. The skilled reader realizes that the LAN-setup is equally applicable in the embodiments discussed in reference to the foregoing figures, and that it was merely omitted in order to avoid clogging in the illustrations.

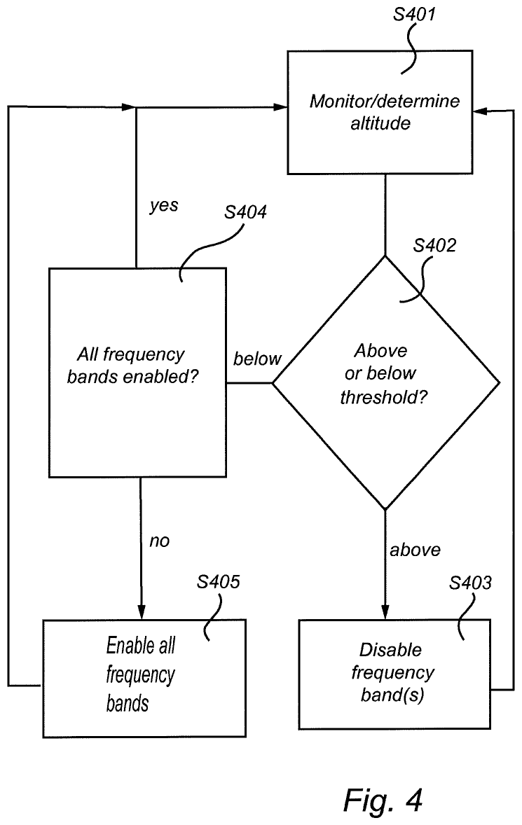

FIG. 4 is a schematic flow chart representation of a method for wireless data communication between a wireless communication system in an aircraft and a stationary communication server outside the aircraft, in accordance with an embodiment of the invention.

Firstly, a router is provided within the aircraft. The router may be any router according to any of the above discussed embodiments of the inventive wireless communication system. The router is connected to at least one antenna and configured to transmit and receive wireless data communication to and from the stationary communication server outside the aircraft through at least one ground base station via the at least one antenna. Moreover, the router is specifically configured to transmit and receive wireless data communication on a plurality of different frequency bands.

Next, an altitude of the aircraft is monitored/determined, S401. Once the altitude is determined by an altitude determining unit or any control unit of the router, a check is performed, S402, to see whether the determined altitude of the aircraft is above or below an altitude threshold value. If it is determined that the altitude of the aircraft is above the altitude threshold value, wireless data communication is disabled, S403, on at least one frequency band of the plurality of different frequency bands. Preferably, the highest frequency band(s) is/are disabled (e.g. all frequency bands above 1 GHz) once the aircraft goes above the altitude threshold value.

However, if it would have been determined that the altitude of the aircraft was below the altitude threshold value, a check is performed, S404, to see if all frequency bands are enabled. If all frequency bands are determined to be enabled, one goes back to monitoring/determining, S401, the altitude of the aircraft, if one or more frequency bands are determined to be disabled, one preferably enables all frequency bands, S405, and then returns back to monitoring/determining, S401, the altitude of the aircraft.

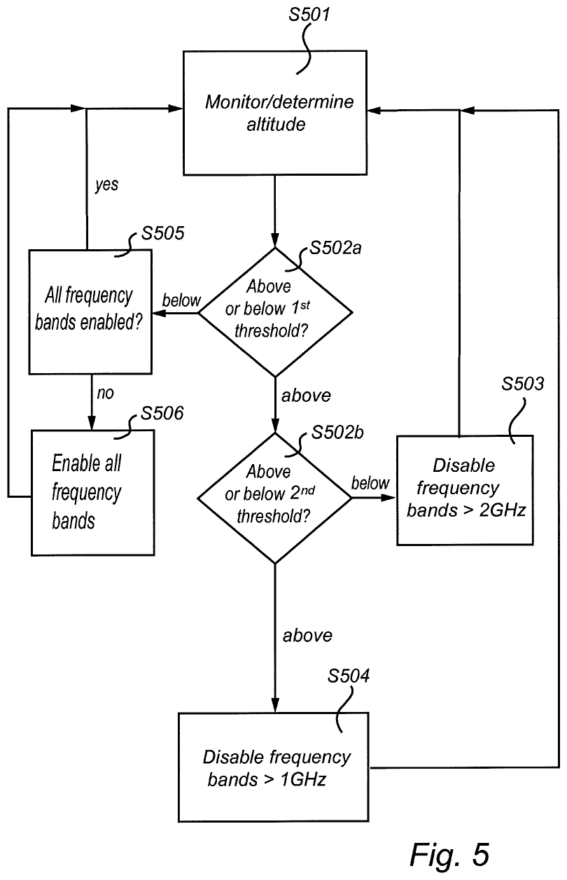

In FIG. 5 another flow chart representation of a method for wireless data communication in accordance with another embodiment of the present invention is illustrated. In this particular embodiment, there are two different altitude threshold values provided in order to make the method more dynamic and agile. More specifically, the method illustrated in FIG. 5 enables for better utilization of the higher frequency bands since it is based on an optimization scheme. Similar to the method described in reference to FIG. 4, a router according to any of the previously discussed embodiments of the invention is provided, and the altitude of the aircraft is monitored/determined (e.g. by an altitude determining unit).

Further, a check is performed, S502a, to see if the altitude of the aircraft is above or below a first altitude threshold value (e.g. above 500 m). If it is determined that the aircraft is above the first altitude threshold value, the method proceeds with checking, S502b, if the altitude of the aircraft is above or below a second altitude threshold value (e.g. above 1000 m). If the aircraft's altitude is determined to be below the second altitude threshold value (but above the first altitude threshold value) all frequency bands above 2 GHz are disabled, S503. However, if it would have been determined that the aircraft's altitude was above the second altitude threshold value as well, then wireless data communication on all frequency bands above 1 GHz are disabled. After each decision to disable one or more frequency bands, one preferably returns to monitoring/determining, S501, the altitude of the aircraft. The method may further comprise three, four or even more altitude thresholds in order to further control the allowable frequency bands for specific altitude ranges.

However, stepping back a few steps, if it would have been determined that the altitude of the aircraft was below the first threshold value, the method preferably comprises a step of checking, S505, if all frequency bands are enabled, similar to the method discussed in reference to FIG. 4. Thus, if all frequency bands are enabled, go back to monitoring/determining, S501, the current altitude of the aircraft, if not, proceed with enabling all frequency bands, S506, and then go back to monitoring/determining, S501, the current altitude of the aircraft.

The invention has now been described with reference to specific embodiments. However, several variations of the communication system are feasible. For example, the control unit may restrict communication to certain frequency bands at certain altitude ranges, the number of modems and SIMs may vary, and so on. Further, a plurality of altitude thresholds may be utilized, as already exemplified. Such and other obvious modifications must be considered to be within the scope of the present invention, as it is defined by the appended claims. It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting to the claim. The word “comprising” does not exclude the presence of other elements or steps than those listed in the claim. The word “a” or “an” preceding an element does not exclude the presence of a plurality of such elements.

1. A wireless communication system for an aircraft, said wireless communication system comprising:
at least one antenna;
a router connected to said at least one antenna, wherein the router is configured to transmit and receive wireless data communication to and from a stationary communication server outside said aircraft through at least one ground base station via said at least one antenna, wherein the router is configured to transmit and receive wireless data communication on a plurality of different frequency bands;
an altitude determining unit configured to determine a current altitude of said aircraft; and
wherein said router comprises a control unit operably connected to said altitude determining unit, said control unit being configured to disable wireless data communication on at least one frequency band when the current altitude is determined to be above an altitude threshold value.

2. The wireless communication system according to claim 1, wherein said plurality of different frequency bands comprises a first frequency band and a second frequency band, said second frequency band being a highest frequency band out of said plurality of frequency bands; and
wherein said control unit is configured to disable wireless data communication on the second frequency band when the current altitude is determined to be above the altitude threshold value.

3. The wireless communication system according to claim 1, wherein said plurality of different frequency bands comprises:
a first set of frequency bands and a second set of frequency bands, wherein each frequency band in said second set of frequency bands is at a higher frequency than each frequency band in said first set of frequency bands; and
wherein said control unit is configured to disable said wireless data communication on said second set of frequency bands, and thereby restrict said wireless data communication only to said first set of frequency bands, when the current altitude is determined to be above an altitude threshold value.

4. The wireless communication system according to claim 3, wherein said control unit is further configured to prioritize a selection of said second set of frequency bands when the current altitude is determined to be below said altitude threshold value.

5. The wireless communication system according to claim 3, wherein said first set of frequency bands comprises frequency bands below 1 GHz and wherein said second set of frequency bands comprises frequency bands above 1 GHz.

6. The wireless communication system according claim 1, wherein said altitude threshold value is within the range of 200-5000 meters.

7. The wireless communication system according to claim 1, further comprising a plurality of antennas, and wherein the router further comprises a plurality of modems for communication with said external stationary communication server, each modem being associated with and connected to at least one antenna;
wherein each modem is further associated with a specific frequency band selected from the plurality of frequency bands; and
wherein said control unit configured to disable wireless communication on at least one frequency band when the current altitude is determined to be above a threshold value, by disabling at least one modem.

8. The wireless communication system according to claim 1, wherein the router comprises at least eight modems.

9. The wireless communication system according to claim 1, wherein said altitude determining unit is configured to continuously monitor and determine the altitude of said aircraft.

10. The wireless communication system according to claim 1, wherein said altitude determining unit is provided within the router.

11. The wireless communication system according to claim 1, wherein said altitude determining unit is a Global Navigation Satellite System, GNSS, unit.

12. The wireless communication system according to claim 1, wherein said altitude threshold value is a first altitude threshold value; and
wherein said control unit is further configured to disable wireless data communication on at least one other frequency band when the current altitude is determined to be above a second altitude threshold value, higher than said first altitude threshold value, such that wireless data communication on at least two frequency bands is disabled when the current altitude is determined to be above the second threshold value.

13. The wireless communication system according to claim 1, wherein at least one of the altitude threshold value(s) is dynamically adjustable.

14. A method for wireless data communication between a wireless communication system in an aircraft and a stationary communication server outside the aircraft, said method comprising:
providing a router within the aircraft, the router being connected to at least one antenna and configured to transmit and receive wireless data communication to and from the stationary communication server outside the aircraft through at least one ground base station via said at least one antenna, wherein the router is configured to transmit and receive wireless data communication on a plurality of different frequency bands;
determining a current altitude of the aircraft; and
disabling wireless data communication on at least one frequency band out of said plurality of different frequency bands when the current altitude is determined to be above an altitude threshold value.

15. The method according to claim 14, further comprising:
forming a first subset of frequency bands out of the plurality of different frequency bands;
forming a second subset of frequency bands out of the plurality of different frequency bands, each frequency band in the second subset of frequency bands being of a higher frequency than each frequency band in the first subset of frequency bands; and
wherein the step of disabling wireless data communication comprises disabling wireless data communication on the second subset of frequency bands when the current altitude is determined to be above the altitude threshold value.
